(19) United States
(12) Patent Application Publication
(10) Pub. No.: US 2003/0160480 A1
(43) Pub. Date: Aug. 28, 2003

(54) Motor vehicle seat comprising a part made of aluminum foam controlling the deceleration of a passenger's pelvis

(75) Inventors: Rodolphe Allera, Saint Vrain (FR); Alain Laporte, Guyancourt (FR); Laurent Lecrosnier, Guyancourt (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: RENAULT, Boulogne Billancourt (FR)

(21) Appl. No.: 10/383,694

(22) Filed: Mar. 10, 2003

Related U.S. Application Data
(63) Continuation of application No. 09/786,237, filed on Jun. 19, 2001, now abandoned.
Application No. 09/786,237 is a 371 of international application No. PCT/FR99/02105, filed on Sep. 3, 1999.

(30) Foreign Application Priority Data
Sep. 4, 1998 (FR) 98/11090

(51) Int. Cl. B60R 21/00

(52) U.S. Cl. 297/216.1

(57) ABSTRACT

The invention concerns a motor vehicle seat (1) characterised in that it comprises in its seating portion (3) a part (6) controlling the deceleration of the pelvis of the passenger seated thereon, particularly during a frontal impact, consisting of an element in aluminium foam. The invention is applicable to motor vehicle seats.

The present invention relates in general to a motor vehicle seat, in particular to a seat equipped with a safety belt, the bottom of which seat is provided with a portion for controlling the deceleration of an occupant's pelvis during a collision, especially a frontal collision of the vehicle.

Improvement of the safety of motor vehicle occupants, especially during collisions, has become a constant concern of automobile manufacturers.

Thus the use of seats equipped with safety belt webbings prevents the occupant from being thrown forward during a vehicle collision, especially during a frontal collision.

Nevertheless, because of the presence of the safety belt webbing, the tensile force exerted in forward direction on the webbing following the abrupt deceleration of the vehicle during a collision of the vehicle, especially of the frontal type, is partly transformed into a force that tends to make the occupant slide forward along the seat.

To prevent this forward movement (submarining) of the occupant, it has been proposed that a hollow metal cylindrical member covered with a layer of material forming a cushion be placed in transverse orientation in the front portion, slightly raised above the seat bottom. Such a solution is described in British Patent 1348873. Nevertheless, this solution suffers from the drawback that the transverse metal member is permanently deformed during a collision and can exert on the occupant's pelvis a compressive force large enough to cause injuries.

To prevent submarining, U.S. Pat. No. 4,623,192 proposes that there be included in the front portion of the seat bottom a member which, in the event of collision, is thrust upward by means of a mechanism connected to the anchor point of the safety belt webbing on the seat, thus limiting the forward movement of the occupant's pelvis. This movable member may be made of a material similar to that of the rest of the cushions of the seat or of a material having relatively high resistance to compression. Besides the fact of its complexity and of the necessity of anchoring the safety belt webbing on the seat, this device exhibits, as before, the drawback of exerting a large compressive force on the occupant's pelvis.

It therefore appears to be desirable to develop a motor vehicle seat which, while preventing the occupant from sliding in forward direction along the seat (submarining), would make it possible to control the deceleration of the occupant's pelvis during a collision of the vehicle, especially of the frontal type.

It has now been found that, by using an aluminum foam, it was possible to provide in the bottom of the vehicle seat a portion which limits how much the occupant slides in forward direction along the seat and at the same time controls the deceleration of the occupant's pelvis in the event of collision, especially of the frontal type.

According to the invention, there is achieved a motor vehicle seat provided with a bottom and a back, characterized in that the bottom is provided with at least one portion made of an aluminum foam member for controlling the deceleration of the pelvis of an occupant seated on the seat.

The aluminum foam member comprising the portion for controlling the deceleration of the pelvis may be a separate member or else may be an integral part of the structure of the seat bottom. In particular, the aluminum foam member may be a separate member embedded in the seat bottom at the appropriate position, or may be formed from one single part molded in its entirety together with the frame of the bottom.

Quite obviously, the aluminum foam member is made in the desired shapes and dimensions in order to perform its function as a portion for controlling the deceleration of the pelvis in the event of collision of the vehicle. Thus the thickness of the aluminum foam member will generally range from 50 to 100 mm, preferably from 80 to 100 mm. Quite obviously the aluminum foam member constituting the portion for controlling the deceleration of the pelvis must be situated in the seat bottom in such a way that the force exerted by the occupant's pelvis during a collision is applied on this aluminum foam member.

Aluminum foams are known products which are commercially available.

In general, these foams are made of an aluminum alloy such as AlSi₉Cu₃ or AlSi₁₀Mg and silicon carbide (SiC), and are products having densities ranging from 0.10 to 0.40.

The aluminum foams preferred according to the invention have a density of 0.10 to 0.30 and more preferably of 0.15 to 0.20.

The aluminum foams which are appropriate for the present invention generally exhibit a stabilized force of less than 10 kN for a deformation ratio ranging from 50 to 95%, preferably from 55 to 95%, and more generally from 70 to 85%.

In addition, the aluminum foams are lightweight materials (about 250 g/l depending on density) and are isotropic, which means that they exhibit the same behavior regardless of the direction of the applied force.

The aluminum foam member constituting the portion for controlling the deceleration of the pelvis may be provided with a skin on the surfaces perpendicular to the applied force, especially for the low-density aluminum foam members, thus making it possible to obtain a more constant force plateau.

As examples of aluminum foams which are appropriate for the present invention, there can be cited the foams sold by the ALCAN Co. (AA 359 foam alloy+SiC, which has a density ranging from 0.10 to 0.35), and by the HYDROALUMINIUM Co. (AlSi₉Cu₃ alloy+SiC, which has a density of 0.20 to 0.40, and AlSi₁₀Mg alloy+SiC, which has a density of 0.20 to 0.30).

The rest of the description refers to the attached figures, which depict, respectively:

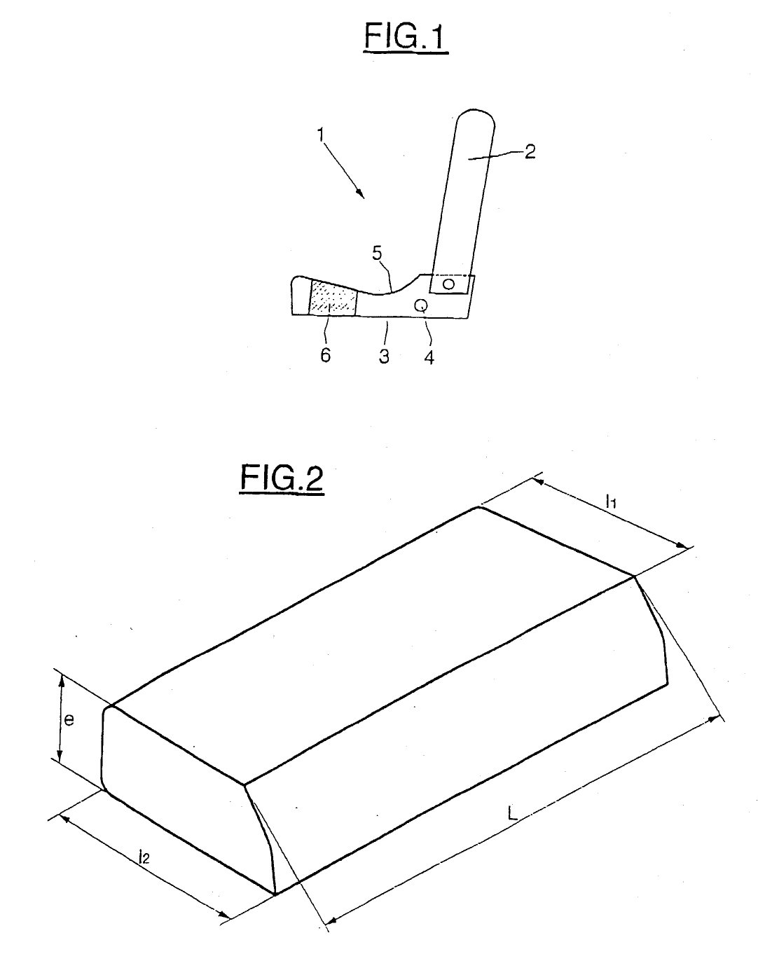

FIG. 1—a schematic view of a motor vehicle seat whose bottom is provided with a portion comprising an aluminum foam member according to the invention for controlling the deceleration of the pelvis of the occupant;

FIG. 2—a perspective view of an aluminum foam member according to the invention, in the form of a separate member;

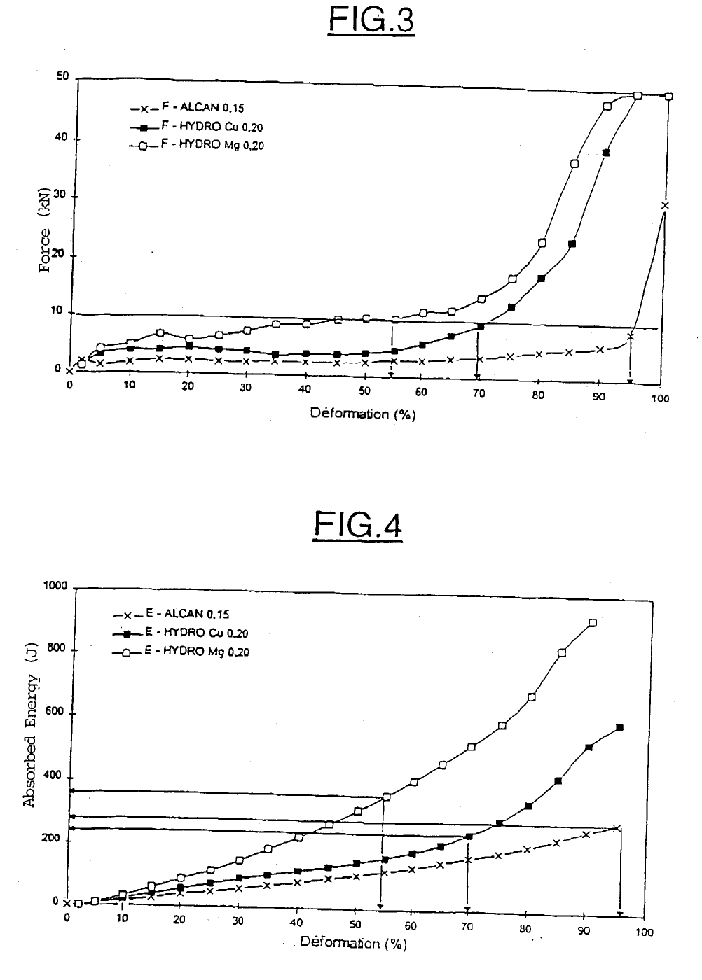

FIG. 3—a graph of force versus deformation for aluminum foam blocks with a thickness of 90 to 100 mm;

FIG. 4—a graph of absorbed energy versus deformation for the same foam blocks as for FIG. 3;

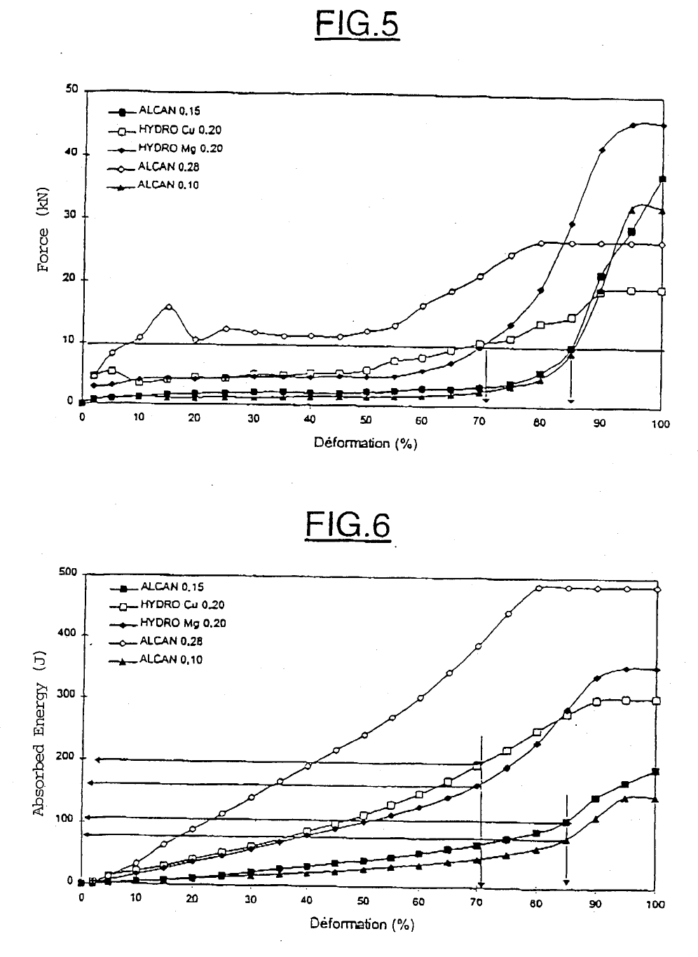

FIG. 5—a graph of force versus deformation for aluminum foam blocks with a thickness of 50 mm; and

FIG. 6—a graph of absorbed energy versus deformation for the same aluminum foam blocks as for FIG. 5.

FIG. 1—a motor vehicle seat 1 according to the invention, provided in classical manner with a back 2 joined to a bottom 3. Bottom 3 generally comprises a reinforcing member 4 and a cushion 5.

According to the invention, an aluminum foam member 6 is disposed in one portion, generally a front portion, of seat bottom 3, to constitute the portion for controlling the deceleration of the occupant's pelvis in the event of collision of the vehicle, especially of the frontal type.

As indicated in the foregoing, this aluminum foam member may be an integral portion of framework member 4 of the seat or may be a separate member embedded at the desired position in cushion 5 of the seat.

FIG. 2 shows an aluminum foam member according to the present invention in the form of a separate member designed to be embedded in the cushion of the seat.

As shown by FIG. 2, this separate member has the general shape of a parallelepiped, whose dimensions are chosen so as to ensure that the effect on controlling the deceleration of the occupant's pelvis in the event of collision is effective. In particular, the length L and the maximum width 12 of the member are sufficient for the entirety of the occupant's pelvis to rest above the member. Thus the member can have a length L of about 400 mm or more, a width 12 of 180 to 300 mm at its lower face, and a width 11 of 150 to 200 mm at its upper face. In addition, the thickness e of the member must be sufficient to absorb the energy applied during a collision, and generally ranges between 50 and 100 mm, preferably between 80 and 100 mm.

To demonstrate the effectiveness of aluminum foam members according to the invention, quasi-static compression tests were performed on different aluminum foam blocks having densities of between 0.10 and 0.40, using a ROELL and KORTHAUS test machine of 50 kN capacity and a hemispherical impactor with a diameter of 100 mm. The compression impacts were performed at a velocity of 20 mm/min.

In addition, the following criteria were fixed:

Force: 10 kN, not to exceed

6 kN in the axis of the spinal column

4 kN at 20 mm of movement of the spinal column

Energy: 180 to 220 joules

The aluminum foam members tested were blocks having thicknesses of 50 mm and of 90 to 100 mm.

The aluminum foams used were:

For the blocks of 90 to 100 mm:

ALCAN 0.15: AA 359 alloy+SiC, with a density of 0.15, from the ALCAN Co.,

HYDRO 0.20: AlSi₉Cu₃ alloy+SiC, with a density of 0.20, from the HYDROALUMINIUM Co.,

HYDRO Mg 0.20: AlSi₁₀Mg alloy+SiC, with a density of 0.20, from the HYDROALUMINIUM Co.

Block with thickness of 50 mm:

ALCAN 0.15: AA 359 alloy+SiC, with a density of 0.15, from the ALCAN Co.,

HYDRO Cu 0.20: AlSi₉Cu₃ alloy+SiC, with a density of 0.20, from the HYDROALUMINIUM Co.,

HYDRO Mg: AlSi₁₀Mg alloy+SiC, with a density of 0.20, from the HYDROALUMINIUM Co.,

ALCAN 0.28: AA 359 alloy+SiC, with a density of 0.28, from the ALCAN Co.,

ALCAN 0.10: AA 359 alloy+SiC, with a density of 0.10, from the ALCAN Co.

FIGS. 3 and 4 show the relationship between force and deformation for the aluminum foam blocks of 90 to 100 mm thickness, whereas FIG. 4 is a graph of absorbed energy as a function of deformation for these same blocks. These figures show that, for the three materials tested, the absorbed energy ranges between 200 and 380 joules while the compression ratio varies from 95 to 55%.

Thus, if the maximum force is fixed at 10 kN, the blocks are capable of meeting the imposed criteria.

FIGS. 5 and 6 are graphs of force and of absorbed energy as a function of deformation for the blocks of 50 mm thickness.

Particularly in the case of the blocks of small thickness, and for the foams of low density of less than or equal to 0.20, it is apparent that the force can be kept below 10 kN with a high deformation ratio (from 70 to 85%). Since the available crushing length is smaller than in the case of blocks of large thickness, the absorbed energy is quite obviously smaller than that in the tests performed with the blocks of larger thickness.

Nevertheless, the crushing force during compression is found to be stable in all cases.

1. A motor vehicle seat comprising a bottom (3) and a back (2), characterized in that the said bottom (3) is provided with a portion made of an aluminum foam member (6) for controlling the deceleration of the pelvis of a person seated on the seat.

2. A seat according to claim 1, characterized in that the portion for controlling the deceleration is in the form of a separate member.

3. A seat according to claim 1, characterized in that the portion for controlling the deceleration is formed integrally with the seat bottom.

4. A seat according to any one of claims 1 to 3, characterized in that the aluminum foam has a density of 0.10 to 0.40, preferably 0.15 to 0.20.

5. A seat according to any one of claims 1 to 4, characterized in that the portion for controlling the deceleration exhibits a stabilized force of less than 10 kN for a deformation ratio ranging from 50 to 95%, preferably from 55 to 95%.

6. A seat according to claim 5, characterized in that the deformation ratio ranges between 70 and 85%.

7. A seat according to any one of claims 1 to 6, characterized in that it is equipped with a safety belt.

8. The use of an aluminum foam member to provide in the bottom of a motor vehicle seat a portion for controlling the deceleration of the pelvis of a person seated on the seat.

9. The use according to claim 8, characterized in that the aluminum foam member has a density ranging from 0.10 to 0.40, preferably from 0.15 to 0.20
